(19) United States
(12) Patent Application Publication
(10) Pub. No.: US 2016/0183495 A1
(43) Pub. Date: Jun. 30, 2016

(54) Canine Garments to Cover, Enclose, and Protect Ears from Inclement Weather

(71) Applicant: Dara Emily Moss, Jersey City, NJ (US)

(72) Inventor: Dara Emily Moss, Jersey City, NJ (US)

(21) Appl. No.: 14/585,134

(22) Filed: Dec. 29, 2014

(51) Int. Cl. A01K 13/00

(52) U.S. Cl. CPC A01K 13/006

(57) ABSTRACT

This invention relates to three variations of a garment that encloses a canine's ears individually to keep them warm in cold climates. Two different hat variations provide different degrees of warmth and methods of use. A “Hoodie” variation consists of a jacket with an integrated hood that encloses the ears individually but can be pulled back off the head if the dog does not want to wear it. Each of the variations of the invention can make use of different materials to provide the right degree of warmth based on the climate and suseptibility to cold based the dog's breed and age. The first variation of the invention is a hat that covers the head and individual ears and is held in place with strips of hook and loop material affixed to the bottom of the hat with attach to each other under the dog's “chin”. The second variation is a “Sport” hat which pulls over the dog's head and is held in place by elastic trim that surrounds the dog's face. This version also provides extra warmth by providing a tighter fit around the dog's head and a longer neck. The third variation of the invention is a “Hoodie” that features an integrated jacket and hat portion that can be pulled back off the head by the owner.

### CROSS-REFERENCE TO RELATED APPLICATIONS

Not applicable. This is an application for a new invention

### BACKGROUND OF INVENTION

1. Field of the Invention

This invention relates to garment that encloses a canine's ears individually to keep them warm in cold climates and method of using the same.

Many canine breeds have ears that stand upright and are often large in proportion to the animal versus other breeds. Some owners of dog breeds have the animal's ears “cropped” to make them stand upright. Larger upright ears can assist with cooling the dog in warmer weather since upright ears promote efficient heat exchange. In colder weather, the cooling effect of these ears can make these dogs more prone to discomfort and possibly hypothermia. This invention keeps larger upright ears warm in cold weather but can also provide cold weather protection to all canine breeds with all ear types including “rosebud”, tulip and floppy ears even though some of these breeds may not benefit as much as those with “bat”,“rounded-tip” ,“blunt” or cropped upright ears.

This invention includes several variations that provide different levels of protection and methods of use. In addition different fabrics can be used in the construction of the garmet to change its insulating properties allowing the owner of the dog to procure the right protection for their breed and climate.

The invention was first developed by the inventor for her own French Bulldog who was having difficulty with cold climates. She found the invention was very effective and has recently offered it and the variations described to the public on the Etsy website (www.etsy.com) as the BatHat, BatHat Sport and BatHat Hoodie.

### PRIOR ART

There have been other patents for hats and other protective garments for dogs, but none found specifically addressed keeping canine ears individually warm. Most prior art applies to keeping dogs and animals cool in hot weather, not warm in cold weather. One keeps a dog's long floppy ears out of its feeding dish. Unlike prior art, this invention addresses a particularly acute problem in breeds with large, upright ears but can also impact other breeds to a lesser extent. Many hats for dogs in prior art have the ears uncovered entirely.

First Public Disclosure of Invention: Jan. 5, 2014 on Etsy website. Filing date of non-provisional patent is being made within 12 months of that date. The “effective filing date” claimed for this invention is Jan. 5, 2014.

Application US20130066409 A1 Protective clothing and apparel for pets and animals and method of use, Teresa Hilton—This hat does not cover ears nor is coat used for warmth. Instead both are used to keep animals cool in hot weather vs. keep them warm in cold weather.

Patent U.S. Pat. No. 4,233,942 Animal ear protectors, James D. Williams This invention allows owners of long eared dogs to secure the ears so they don't get dirty when the dog is eating. The substance and function of this invention is entirely different than the one in this application.

Patent U.S. Pat. No. 7,946,256 B2/US20100307427 Protective head cover for an animal and method of using the same, Robert E. Mann—This patent is significantly different in that it is designed solely to cover the ear canal to keep foreign material out. It is not designed for warmth and it unsuitable for use by dogs with upright ears.

Patent U.S. Pat. No. 4,969,317A Animal hat apparatus and method, April Ode—This is a cowboy hat that provides shade but leaves dogs with upright ears unprotected in any way.

Patent U.S. Pat. No. 5,163,272 Protective ear canal covering for dogs and other animals, John G. Finley, Mary F. Harris—this is a mosquito net for dogs to protect the ear canal from insects. It provides no insulation. It also would not work well for dogs with large, upright ears.

Patent U.S. Pat. No. 750,505 Heat Protector for Animals, Feanz Kuno Walthee—This 1904 patent provides shade for horses and other animals. It does not address keeping dogs' ears or head warm.

Patent DE 10213615 A1 Garment or covering for animals has cooling or warming effect—Detlev O'Reilly—this invention cools or warms the animal using gel in a jacket that covers the animal's torso but specifically excludes the head.

Patent JPH10113088 (A) To provide a harness for cooling a head, Tadauchi Renji; Sasao Takuhiro—this hat is designed to cool a horse's head.

### SUMMARY OF INVENTION

This invention is a hat that either alone or in combination with an integrated jacket can cover the dog's head and upright ears individually to make the dog comfortable in cold weather. There are at least three major variations of this invention each providing different degrees of protection from the cold, which will be named for the purpose of this patent application: “Original Hat”, “Sport Hat” and “Hoodie.” The Original Hat covers the head and ears individually and is held in place with the bottom of the hat fastening to itself with strips of hook and loop material. The “Sport Hat” version pulls over the dog's head and is held in place by foldover elastic trim around the opening of the hat that surrounds the dog's face. This version also provides extra warmth by providing a tighter fit around the dog's head and a longer neck. The Hoodie version features a jacket integrated with the hat so that can be pulled back off the head by the owner.

### DESCRIPTION OF THE SEVERAL VIEWS OF THE DRAWING

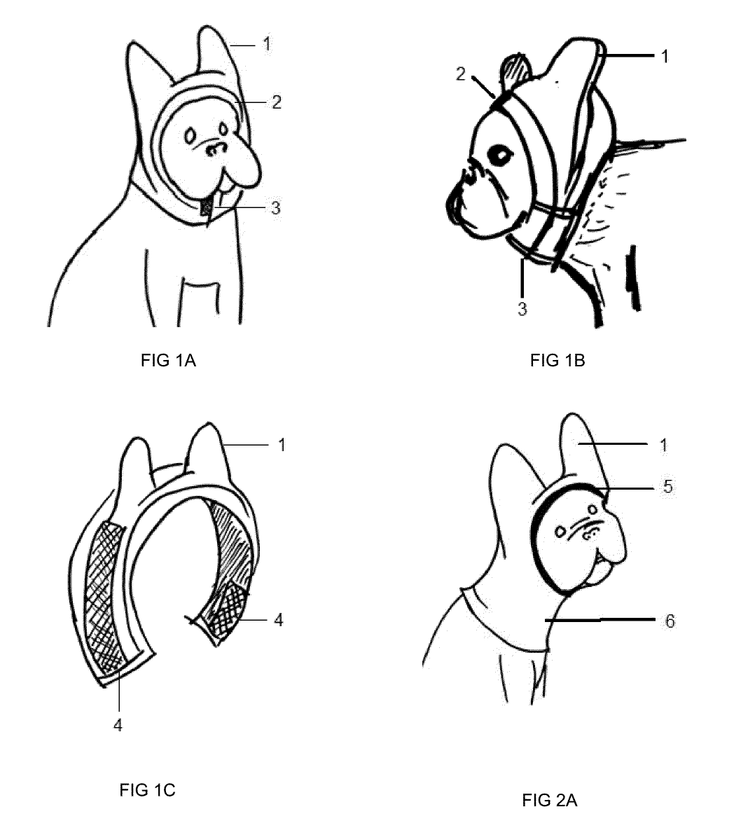

Page 1, FIG. 1A—Shows canine hat covering upright ears—front view

Page 1, FIG. 1B—Shows canine hat covering upright ears—side view

Page 1, FIG. 1C—Shows cut-away of side view portion of canine hat that attaches to itself under dog's chin to keep hat firmly affixed to animal

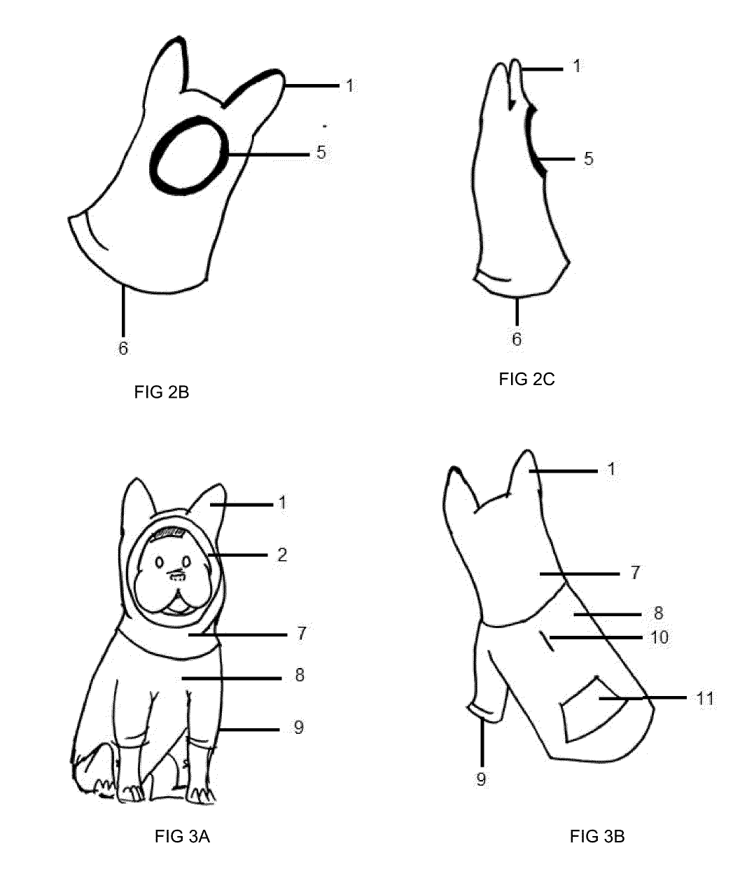

Page 1, FIG. 2A—Shows “sport” version of pullover canine hat covering upright ears, front view on dog

Page 2, FIG. 2B—“Sport” version of pullover hat—front view, without dog

Page 2, FIG. 2C—“Sport” version of pullover hat—side view, without dog

Page 2, FIG. 3A—“hoodie” coat and attached hat shown on dog—front view

Page 2, FIG. 3B—“hoodie” coat and attached hat garment without dog—rear view

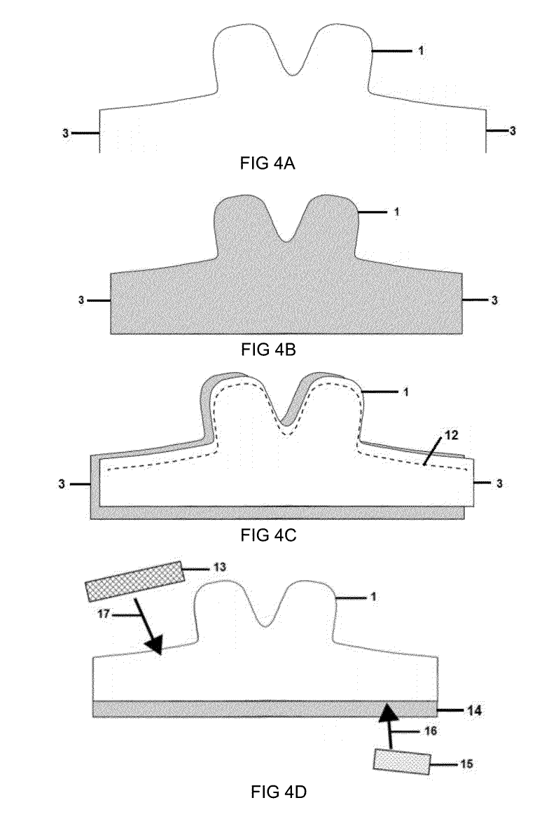

Page 3, FIG. 4A—Manufacturing view of front piece of hat for the regular “hat” variation.

Page 3, FIG. 4B—Manufacturing view of rear piece of hat for the regular “hat” variation

Page 3, FIG. 4C—Manufacturing view of front piece over the rear piece of hat for assembly of the regular “hat” variation and the hat portion of the “hoodie” variation

Page 3, FIG. 4D—Manufacturing view of the pieces of hook and loop tape and the assembled front and rear pieces of hat for the regular “hat” variation and the hat portion of the “hoodie” variation

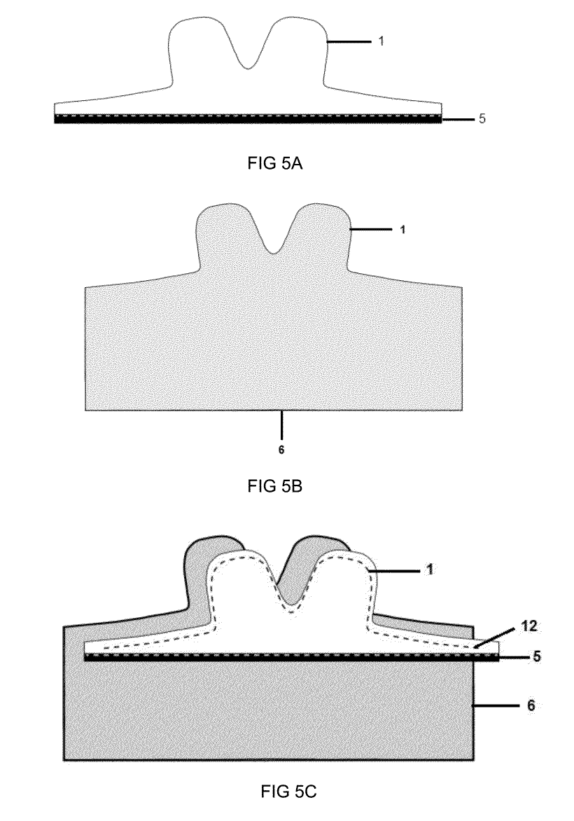

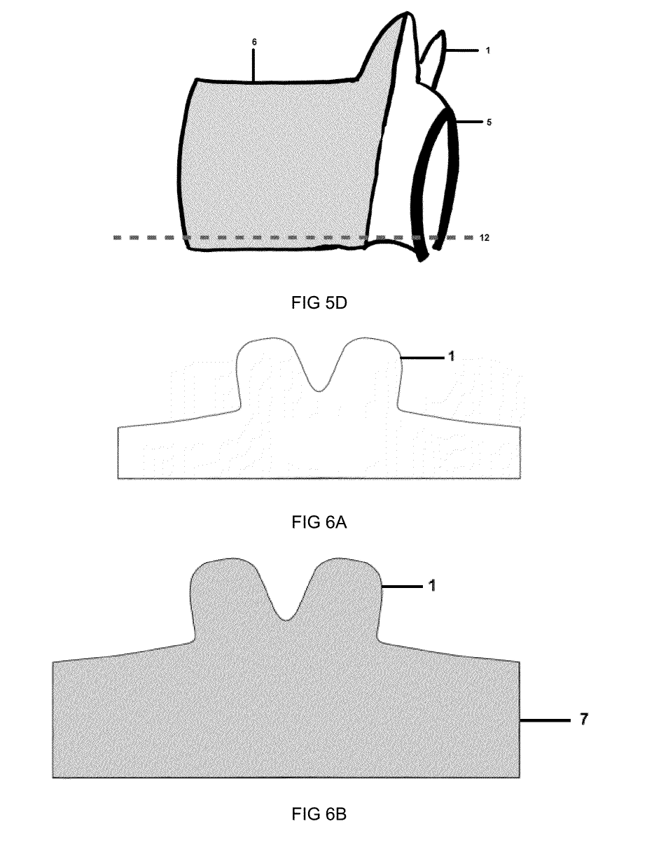

Page 4, FIG. 5A—Manufacturing view of front piece of “sport” version of pullover hat

Page 4, FIG. 5B—Manufacturing view of rear piece of “sport” version of pullover hat

Page 4, FIG. 5C—Manufacturing view of how front and rear pieces of “sport” version of pullover hat are sewn together to enclose ears

Page 5, FIG. 5D—Manufacturing view of final assembly of “sport” version, side view

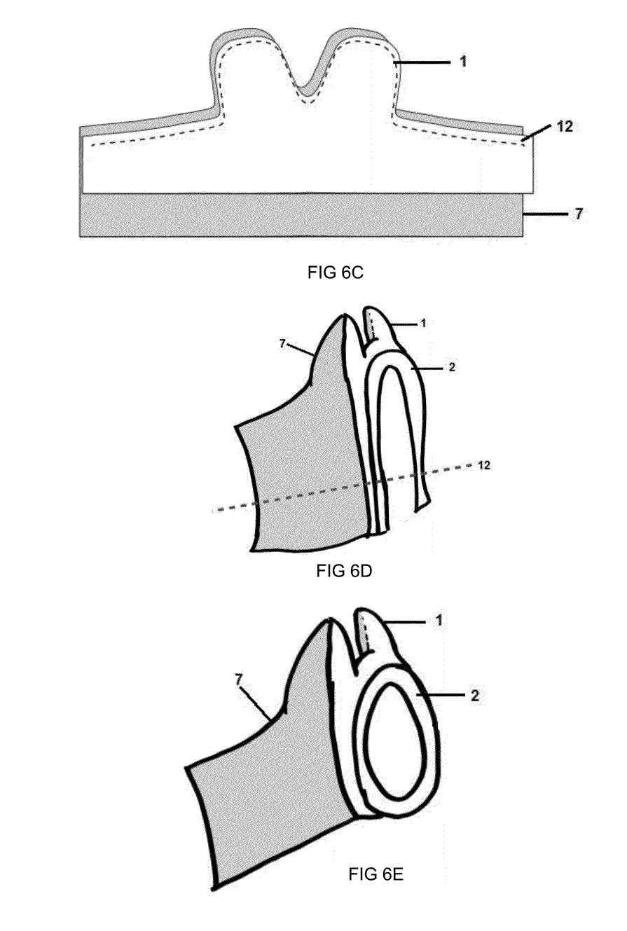

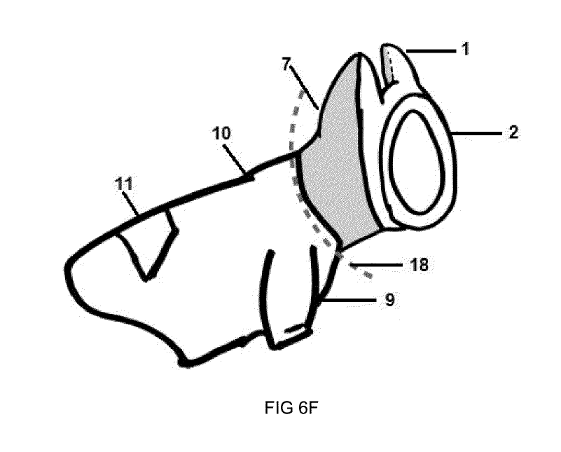

Page 5, FIG. 6A—Manufacturing view of front piece of hat portion of hoodie version

Page 5, FIG. 6B—Manufacturing view of rear piece of hat portion of hoodie version

Page 6, FIG. 6C—Manufacturing view of front and rear hat portions of hoodie version showing where they are sewn together

Page 6, FIG. 6D—Manufacturing view of hat portion of hoodie version showing it ready to be cut to size and sewn together to make the hat

Page 6, FIG. 6E—Manufacturing view of hat portion of hoodie version showing it cut to size and sewn together to make the hat prior to attachment to the body of the garment

Page 7, FIG. 6F—Manufacturing view of hat portion of hoodie version shown sewed to jacket portion of garment to create a “hoodie”

### KEY TO NUMBERS ON ILLUSTRATIONS

1—Garment enclosing ears on all variations of the invention
2—Loose brim of hat surrounding face of dog on the “hat” and “hoodie” variation of invention
3—Hat fastening to itself under chin of dog in original hat variation
4—Hook and loop tape used to fasten hat under chin of dog in original hat variation
5—Elastic trim material around periphery of dog's face in “Sport” version of invention
6—Longer neck on “Sport” variation to provide extra warmth and facilitate pull-over method of putting on dog.
7—Long neck on the “Hoodie” variation which attaches to jacket
8—Jacket of “Hoodie” variation of invention
9—Legs of jacket of a length not to restrict movement or interfere with paws of animal
10—Slot in back of jacket to allow for attachment of leash to harness or collar worn under jacket
11—Pocket sewn on back of jacket (optional)
12—Seam that will be sewn to connect two pieces of the garment. In some cases it may require cutting the material to measurements.
13—Loop tape
14—Hems along bottom of two pieces of hat
15—Hook tape
16—Inside portion of the hat where hook tape is sewn
17—Outside portion of the hat where loop tale is sewn
18—Neckline where hat portion of “Hoodie” variation is sewn to the jacket portion

### DETAILED DESCRIPTION OF THE INVENTION

Three variations of the Canine Garments to Cover, Enclose, and Protect Ears from Inclement Weather are illustrated in the drawings. Each variation of design offers differing degrees of warmth and each can use different materials to provide a wider range of warmth. Examples of fabrics suitable for providing warmth can be defined as polar fleece, fleece, felt, velour, velvet, knits, knitted or crocheted yarns. Examples of fabrics that can provide protection from inclement weather (moisture and wind) can be defined as hard-faced fleeces, windproof fabrics, waterproof fabrics, water-resistant fabrics (DWR-treated fabrics), vinyl, and other performance fabrics designed for outdoor use.

The first variation illustrated in FIG. 1A, 1B and 1C is the original hat that will cover the dog's ears (1) surrounds the face (2) and is secured under the dog's chin by a strips of hook and loop material (4) sewn into the inner side of one side of the hat and the outer side of the other side (FIG. 1C).

The second variation illustrated in FIGS. 2A, 2B and 2C shows the “Sport” variation of the invention that features a section of fold-over elastic (5) that hugs the perimeter of the dog's face and holds the hat in place instead of using two pieces of material that fasten under the chin as in the Original Hat variation. The neck of the hat is longer, allowing the fabric around the neck to provide additional warmth and protection from the elements. This hat is put on the dog by pulling it over the canine's head.

The third variation illustrated in FIGS. 3A and 3B shows a hat with features from both the first two variations, configured to be the hood on a hooded shirt, sweatshirt, or coat. Like the first variation, it isn't snug around the perimeter of the dog's face, but instead, the fabric is hemmed to create a brim around the face (2). Like the second variation, the hood is longer in the neck (6)—not only to keep the dog's neck warm and covered, but also so it's long enough to attach to the body of the hoodie garment. The body of the hoodie garment is wider around the chest and shoulders to accommodate barrel-chested breeds like French Bulldogs, English Bulldogs, etc. The pocket on the back of the hoodie (11) could be used to hold small objects. The hood is designed to remain just loose enough so the owner can pull it back.

This “hoodie” configuration also has an opening (10) on the top side of the jacket above the dog's shoulders to allow a leash to connect to a harness or collar worn by the dog under the jacket. A separation is shown between the neck of the hat and the body of the jacket (18) but these are actually sewn together. Frequently the hat portion and the jacket portion are different colors. The “hoodie” configuration is pulled over the dog's head, then the paws are inserted into the legs.

What these designs have in common is that they all cover the dog's ears individually and all can be varied in warmth by using fabrics of different types, wind resistance and water resistance. Fabric is cut in different sizes to accommodate the needs of different canine breeds. The garments must not only accommodate the different proportions and sizes of different breeds but the need for protection from the climate based on the dog's breed and age. For a proper fit, owners must take accurate head and neck measurements in a prescribed way. There must also be enough room within the garment to provide sufficient room for movement and comfort so the dog does not try to remove it.

Manufacturing Process: A pattern is used to cut the fabric according to the specifications for each variation of this invention.

### Original Canine Hat (First Variation of Invention):

This first variation of the invention has two components with a pattern for each. The front piece (FIG. 4A) is cut to surround the dog's ears and is shorter than the rear piece (FIG. 4B). After hemming the bottom of each piece (14), the two pieces are sewn along the top (12 of FIG. 4C) forming the hat. A piece of hook tape (15) is sewn on the interior of one side of the hat (16). A piece of loop tape (13) is sewn along the exterior of the outside of the hat (17). This is also shown in FIG. 1C with the hook and loop tape shown as (4) in that drawing.

### Sport Variation:

Each pattern has two main components, a front (FIG. 5A) and rear (FIG. 5B) section. Rear piece covers the dog's head. Front piece is sewn to rear piece with the right side of the fabric facing each other. A sewing machine is used to join the pieces together. After sewing is completed, the hat is turned inside out.

A length of fold-over elastic (5) is sewn across the bottom of front piece (See dotted line in FIG. 5A). The hat is folded in half on its vertical axis. The elastic is measured so that it is half the length of the measured circumference of the dog's face. The measurement necessary for a proper fit is taken just in front of the dog's ears, around the sides and underside of the dog's head. The elastic trim is folded and hemmed around the face. The elastic holds the hat tight enough to the face so no other fastening is needed unlike the Original Hat variation of the invention. Hat is then sewn down the front (12 in FIG. 5C) to create a pullover hat.

### Hoodie Variation:

Unlike the “Original” and “Sport” hat designs which are each made up of two pieces, the “Hoodie” variation is assembled from seven pieces. The front piece (FIG. 6A) is hemmed on the bottom to create a wide brim around the dog's face. This brim allows the hood to easily be pulled back off the dog's face and even protects the sides of the face from wind and precipitation. The back of the hood (FIG. 6B) is longer than the back of the “Original Hat” variation to keep the neck warm and to attach to the body of the “Hoodie” garment.

After hemming the bottom of the front of the hood (FIG. 6A) to create the brim, the piece is sewn to back piece (FIG. 6B) along top (12 of FIG. 6C). The front of hood is folded along the vertical axis of the hat and is sewn closed down the front (FIG. 6D). The neck and head openings are based on the size of the hoodie as determined by the dog's measurements.

Hood is sewn to the body of the hoodie at the neck (18) FIG. 6F. The body of the hoodie features a pocket, an opening for a leash that can be attached to a harness or collar worn under the hoodie.

1. A hat for dogs which encloses their ears individually to keep them warm. (FIGS. 1A, 1B & 1C)
a. Hat is fastened by flaps below the dog's chin (3) using hook and loop material (4). This promotes a good fit while making it very easy for the dog's owner to put it on and remove.

2. A hat for dogs which encloses the ears individually as well as the dog's neck and uses elastic material around the circumference of the dog's face for keeping it on securely.
a. Hat is held in place by elastic or elastic trim that goes around the of the dog's face
b. This elastic also provides additional protection from the elements by preventing wind and precipitation from entering the hat.
c. This design provides even more warmth that the regular hat by covering the dog's neck.
d. The pullover design is also easy for the owner to take the hat on and off.

3. A “hoodie” for dogs that covers the dog's torso, top of the front legs and includes an integrated hat in the form of a hood that covers upright ears that can be pulled back by the owner.
a. An opening at the back of the neck allows the owner to attach a leash to a harness or collar worn under the “hoodie.”
b. A brim/cowl around the face of the dog provides extra protection from wind and precipitation but also allows the hat to be loose enough to act as a hood so it can be pulled back off the head if the dog does not want to wear it.
